(19) United States
(12) Patent Application Publication
(10) Pub. No.: US 2020/0050327 A1
(43) Pub. Date: Feb. 13, 2020

(54) INPUT APPARATUS

(71) Applicants: PANASONIC CORPORATION, Osaka (JP); MAZDA MOTOR CORPORATION, Hiroshima (JP)

(72) Inventors: Tsuyoshi TANAKA, Kyoto (JP); Ryohei KONO, Kyoto (JP); Keiichiroh YAMAMOTO, Hiroshima (JP); Kohji OHTA, Hiroshima (JP)

(73) Assignees: PANASONIC CORPORATION, Osaka (JP); MAZDA MOTOR CORPORATION, Hiroshima (JP)

(21) Appl. No.: 16/531,423

(22) Filed: Aug. 5, 2019

(30) Foreign Application Priority Data
Aug. 9, 2018 (JP) 2018-149972

(51) Int. Cl. G06F 3/0482; G06F 3/0354

(52) U.S. Cl. CPC G06F 3/0482; G06F 2203/04801; G06F 3/03547

(57) ABSTRACT

An input apparatus includes a touchpad, a display, and a control unit. The control unit displays a pointer on the display such that the pointer is moved in a graphical user interface (GUI). For a selectable object on which a predetermined reference point on the pointer is located among selectable objects, the control unit (i) highlights the selectable object when the predetermined reference point stays on the selectable object for a period longer than or equal to a predetermined stay period, and an amount of movement per unit time of the pointer is smaller than or equal to a predetermined amount of movement, and (ii) avoids highlighting the selectable object when the predetermined reference point stays on the selectable object for a period shorter than the predetermined stay period, or the amount of movement per unit time of the pointer is larger than the predetermined amount of movement.

### CROSS REFERENCE TO RELATED APPLICATION

The present application is based on and claims priority of Japanese Patent Application No. 2018-149972 filed on Aug. 9 2018.

### FIELD

The present disclosure relates to an input apparatus in which a graphical user interface (GUI) is displayed according to input from a touchpad.

### BACKGROUND

PTL 1 discloses an input apparatus in which a cursor (a pointer) displayed on the screen of a personal digital assistant (PDA) is moved in the direction of a detected tilt of the PDA, and the position where the cursor is located is highlighted.

### CITATION LIST

### Patent Literature

[PTL 1] Japanese Unexamined Patent Application Publication No. 2004-246920

### SUMMARY

However, the technique described in PTL 1 can be improved upon. In view of this, the present disclosure provides an input apparatus capable of improving upon the above related art.

An input apparatus according to one aspect of the present disclosure includes: a touchpad; a display; and a control unit that displays a graphical user interface (GUI) having a plurality of selectable objects on the display according to input from the touchpad. The control unit displays a point on the display such that the pointer is moved in the GUI in response to movement of an operating body on the touchpad. For a selectable object on which a predetermined reference point on the pointer is located among selectable objects, the control unit (i) highlights the selectable object when the predetermined reference point stays on the selectable object for a period longer than or equal to a predetermined stay period, and an amount of movement per unit time of the pointer is smaller than or equal to a predetermined amount of movement, and (ii) avoids highlighting the selectable object when the predetermined reference point stays on the selectable object for a period shorter than the predetermined stay period, or the amount of movement per unit time of the pointer is larger than the predetermined amount of movement.

These general and specific aspects may be implemented using a system, a method, an integrated circuit, a computer program, or a computer-readable recording medium such as a CD-ROM, or any combination of systems, methods, integrated circuits, computer programs, or computer-readable recording media.

An input apparatus according to one aspect of the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram illustrating an exemplary configuration of an input apparatus and the interior of a vehicle in which the input apparatus is disposed, according to an embodiment.

FIG. 2 is an external front view of a touchpad viewed from above in the vehicle.

FIG. 3 is a block diagram illustrating an exemplary functional configuration of the input apparatus provided in an automobile, according to the embodiment.

FIG. 4 is a diagram illustrating an exemplary GUI displayed on a display.

FIG. 5 is a diagram for describing the method of performing an input operation in the GUI.

FIG. 6 is a diagram for describing the method of performing an input operation in the GUI.

FIG. 7 is a diagram for describing the method of performing an input operation in the GUI.

FIG. 8 is a diagram for describing the method of performing an input operation in the GUI.

FIG. 9 is a diagram for describing the method of performing an input operation in the GUI.

FIG. 10 is a flowchart illustrating exemplary operations in the input apparatus, according to the embodiment.

FIG. 11 is a flowchart illustrating exemplary operations in the input apparatus, according to the embodiment.

FIG. 12 is a diagram illustrating an exemplary configuration of an input apparatus and the interior of a vehicle in which the input apparatus is disposed, according to a variation.

FIG. 13 is a block diagram illustrating an exemplary functional configuration of the input apparatus provided in an automobile, according to the variation.

### DESCRIPTION OF EMBODIMENT

### Underlying Knowledge Forming Basis of Present Disclosure

The inventor has discovered that the input apparatus mentioned in the Background section has the following disadvantages.

The input apparatus described in PTL 1 is inconvenient in that all selectable objects the cursor overlaps while being moved are highlighted, so that the user performing input operations feels bothered.

Specifically, for the input apparatus in PTL 1, it is disclosed that, when a component such as a gyro sensor in the PDA detects that the PDA is tilted, the cursor (pointer) displayed in the GUI is moved according to the value of the detected tilt, and the position where the cursor is located is highlighted. However, with the technique described in PTL 1, any selectable object the cursor overlaps is highlighted. Selectable objects the cursor overlaps are highlighted even while the cursor is moved, which means that the selectable objects in the cursor path are highlighted. That is, selectable objects that are not the user's intended selectable object are also highlighted. This causes the user performing input operations to feel visually bothered. In addition, the highlight switched from one selectable object to another with the movement of the cursor creates a moving highlight, which obstructs the operation of moving the cursor.

For solving the above inconveniences, the inventor has found, from a careful study, an input apparatus configured as follows.

An input apparatus according to one aspect of the present disclosure includes: a touchpad; a display; and a control unit that displays a graphical user interface (GUI) having a plurality of selectable objects on the display according to input from the touchpad. The control unit displays a point on the display such that the pointer is moved in the GUI in response to movement of an operating body on the touchpad. For a selectable object on which a predetermined reference point on the pointer is located among selectable objects, the control unit (i) highlights the selectable object when the predetermined reference point stays on the selectable object for a period longer than or equal to a predetermined stay period, and an amount of movement per unit time of the pointer is smaller than or equal to a predetermined amount of movement, and (ii) avoids highlighting the selectable object when the predetermined reference point stays on the selectable object for a period shorter than the predetermined stay period, or the amount of movement per unit time of the pointer is larger than the predetermined amount of movement.

In this manner, not all selectable objects in the GUI on which the pointer stays are highlighted. Rather, a selectable object is highlighted on the limited condition that the pointer stays on the selectable object in the GUI for the predetermined stay period, and that the amount of movement per unit time of the pointer in the GUI is smaller than or equal to the predetermined amount of movement. Thus, while the user is moving the pointer to the user's intended selectable object, the control unit can allow the user to see the displayed pointer to recognize, in real time, how or whether the user can be operating. The control unit can also reduce visual bother felt by the user operating the input apparatus due to frequent switching of the highlight from one selectable object to another.

Moreover, when the operating body touches the touchpad, the control unit may display the pointer at a position on the display corresponding to a position at which the operating body has touched the touchpad.

In this manner, when the operating body touches the touchpad, the pointer is displayed at the position in the GUI corresponding to the coordinate position on the touchpad. As such, the pointer can be displayed at a position close to the user's intended selectable object among the selectable objects in the GUI. This enables the user to move the pointer more quickly to the user's intended selectable object. This can also effectively support the user's intuitive operation.

Moreover, the control unit may hide the pointer when the operating body is removed from the touchpad.

In this manner, the pointer is displayed while the operating body touches the touchpad, and hidden while the operating body does not touch the touchpad. This enables more intuitive GUI display according to the user's operational situation.

Moreover, when the operating body touches the touchpad, the control unit may highlight a selectable object, among the plurality of selectable objects, closest to a position on the display corresponding to a position at which the operating body has touched the touchpad.

In this manner, a selectable object close to the user's intended position in the GUI can be highlighted upon a touch on the touchpad. This enables the user to select the intended selectable object more quickly. Even if no selectable object exists at the position on the display corresponding to the coordinates on the touchpad, a relevant selectable object can be highlighted. The user can thus cause a selectable object to be highlighted without making minute adjustment of the position of the operating body on the touchpad in order to select the selectable object. Because the pointer is displayed at the position in the GUI corresponding to the coordinate position on the touchpad, the user's intuitive operation can be effectively supported.

Moreover, the control unit may continue highlighting the selectable object currently highlighted until a predetermined standby period elapses from removal of the operating body from the touchpad, and stop highlighting the selectable object after a lapse of the predetermined standby period.

In this manner, the selectable object remains highlighted for the predetermined standby period after the operating body is removed from the touchpad. As such, even if the user temporarily removes the operating body from the touchpad, the user can resume the operation in the state in which the currently highlighted selectable object is selected. This enables the user to continue the operation without troubles. After a lapse of the predetermined standby period from the removal of the operating body from the touchpad, the highlighting of the selectable object is stopped. Another selectable object can then become the target to be highlighted.

Moreover, when the operating body touches the touchpad again before a lapse of the predetermined standby period from the removal of the operating body from the touchpad, the control unit may display the point at a position at which the selectable object is being highlighted.

Thus, even if the operating body is removed from the touchpad against the user's will, the user can immediately resume the operation of selecting the intended selectable object.

Moreover, the control unit may select the selectable object being highlighted.

In this manner, the control unit selects a selectable object highlighted under the predetermined condition, rather than simply selecting a selectable object on which the pointer stays. Therefore, selection of a selectable object is switched less frequently than in conventional art, so that the user's intuitive operation can be effectively supported.

Moreover, the pointer may be displayed larger than the plurality of selectable objects.

Thus, the pointer or the selectable object under the pointer can be displayed in a manner that facilitates the user's visual recognition.

Moreover, each of the plurality of selectable objects may have a portion that is not overlapped by the pointer when the pointer overlaps the selectable object.

In this manner, the pointer and the selectable object can be displayed to overlap in the GUI in a manner that facilitates the user's visual recognition and identification of the selectable object.

With reference to the drawings, an input apparatus according to an aspect of the present disclosure will be described in detail below.

### Embodiment

### 1. Configuration of Input Apparatus

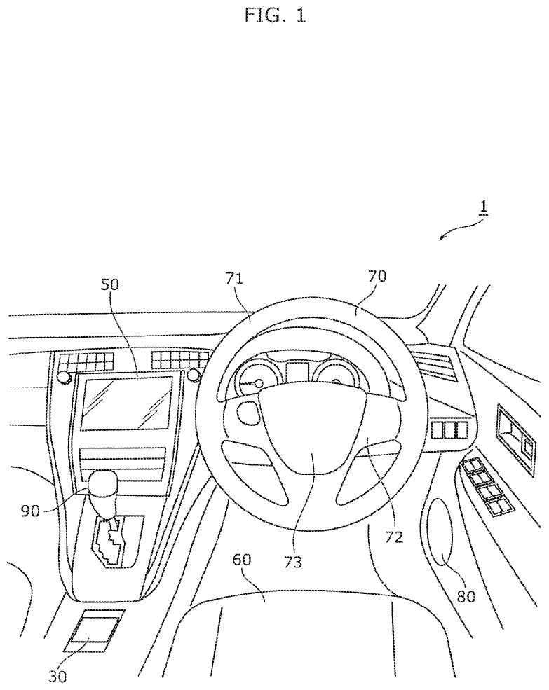

First, the configuration of an input apparatus and the interior of a vehicle in which the input apparatus is disposed, according to an embodiment, will be described with reference to FIG. 1. FIG. 1 is a diagram illustrating an exemplary configuration of the input apparatus and the interior of the vehicle in which the input apparatus is disposed, according to the embodiment. Hereinafter, the forward, rearward, rightward, and leftward directions are defined with respect to the traveling direction of the vehicle. The upward, downward, horizontal, and vertical directions are defined with respect to the vehicle with its wheels contacting the ground.

A touchpad 30 and a display 50, included in an input apparatus 10, are provided in the interior of an automobile 1 (an example of the vehicle) shown in FIG. 1. Further, a shift lever 90 and a steering wheel 70 are disposed in the interior of the automobile 1. The input apparatus 10 is an apparatus for performing input operations on menu screens and search screens serving as GUIs for use in operating devices, e.g., a car navigation system, an audio device for playing optical disks, and a video player. The touchpad 30 is a device through which input operations are performed in the GUI displayed on the display 50 of the input apparatus 10 provided in a vehicle such as the automobile 1.

The touchpad 30 serves as an input interface for performing input operations in the GUI displayed on the display 50 of the input apparatus 10, The user can perform input operations in the GUI to operate the input apparatus 10 in the automobile 1.

The touchpad 30 is disposed rearward of the shift lever 90. That is, the touchpad 30 is disposed at a position accessible to the user sitting in a seat 60 of the automobile 1 but not at a position on the steering wheel 70. The driver, who is the user, can operate the input apparatus 10 with the left hand to provide input to the touchpad 30 disposed rearward of the shift lever 90. The touchpad 30 may not necessarily be disposed at the above-described position as long as the touchpad 30 is at a position accessible to the user and not on the steering wheel 70. While the example in FIG. 1 illustrates the right-hand drive automobile, the example also applies to a left-hand drive automobile, only with right and left reversed.

The steering wheel 70 is used to steer the automobile 1 and has a ring-shaped rim 71, approximately T-shaped spokes 72 formed integrally with the inner circumference of the rim 71, and a horn switch cover 73 that covers a horn switch (not shown) disposed in the center of the spokes 72. The configuration of the touchpad 30 will be described in detail below.

The display 50 displays a car navigation map, a video being played, a GUI for operating the input apparatus 10, GUIs for controlling other in-vehicle devices, and the like. The display 50 is implemented by, for example, a liquid crystal display or an organic EL (Electro Luminescence) display. The input apparatus 10 may be connected to a speaker 80 to output sound through the speaker 80. Other in-vehicle devices may include, for example, an air conditioner such that the operation of the air conditioner is controlled according to input provided to the input apparatus 10.

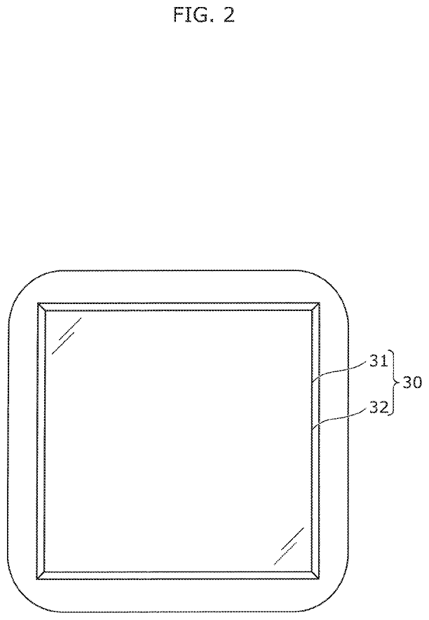

Now, the hardware configuration of the touchpad 30 will be described with reference to FIG. 2.

FIG. 2 is an external front view of the touchpad viewed from above in the vehicle.

The touchpad 30 has a touch sensor 31 and a pressure sensor 32.

The touch sensor 31 is a sensor that receives touches of an operating body 20 operated by the user. The operating body 20 herein may be a finger or a touch pen. Thus, the touch sensor 31 detects the position, in the detection area of the touch sensor 31, touched by a tool such as the user's body part (for example, a finger) or a touch pen for a touch pad. The touch sensor 31 can receive the user's multiple touches, i.e., multi-touches. As such, in addition to the position touched by a single finger, the touch sensor 31 can receive two or three positions simultaneously touched by two or three fingers, respectively.

The pressure sensor 32, disposed in an area overlapping the area of the touch sensor 31, detects push-in inputs to the touchpad 30. For example, an input to the pressure sensor 32 at a pressing force greater than a predetermined pressing force may be received as an input indicating confirmation.

In this embodiment, the touchpad 30 is disposed approximately perpendicularly to the top-bottom direction. That is, the touchpad 30 is disposed such that the touch-receiving side facing upward. Alternatively, the touchpad 30 may be disposed approximately perpendicularly to the front-rear direction. In this case, the touchpad 30 may be disposed such that the touch-receiving side facing rearward, for example.

The user can perform input operations in a GUI 11 displayed on the display 50 of the input apparatus 10 by providing input to the touch sensor 31 and the pressure sensor 32 of the touchpad 30.

While the pressure sensor 32 is used herein as a mechanism for detecting push-in inputs to the touchpad 30, this is not limiting. For example, push switches may be provided immediately below the touch sensor 31 so that the push switches detect push-in inputs to the touchpad 30 at a pressing force greater than a predetermined pressing force.

### 2. Functional Configuration of Input Apparatus

Now, the functional configuration of the input apparatus will be described.

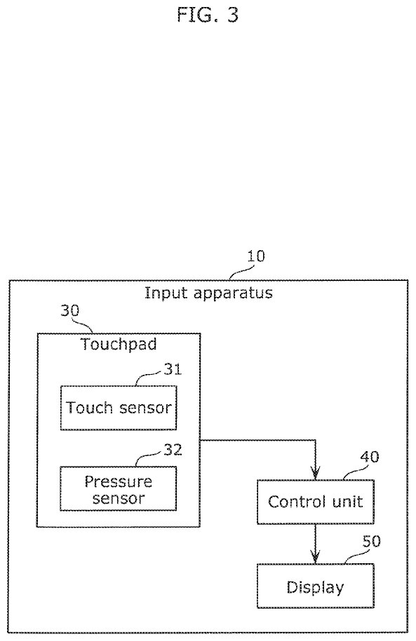

FIG. 3 is a block diagram illustrating an exemplary functional configuration of the input apparatus provided in the automobile, according to the embodiment.

As shown in FIG. 3, the input apparatus 10 includes the touchpad 30, a control unit 40, and the display 50.

When an input is provided to the touch sensor 31 and the pressure sensor 32, an input signal indicating the input is output by the touchpad 30 to the control unit 40.

According to the input signal output by the touchpad 30, the control unit 40 modifies the GUI 11 displayed on the display 50. Details of the control by the control unit 40 according to the input signal will be described below.

The control unit 40 may be implemented by, for example, a processor that executes a predetermined program and memory that stores the predetermined program, or may be implemented by a dedicated circuit. For example, the control unit 40 may be implemented by an electronic control unit (ECU).

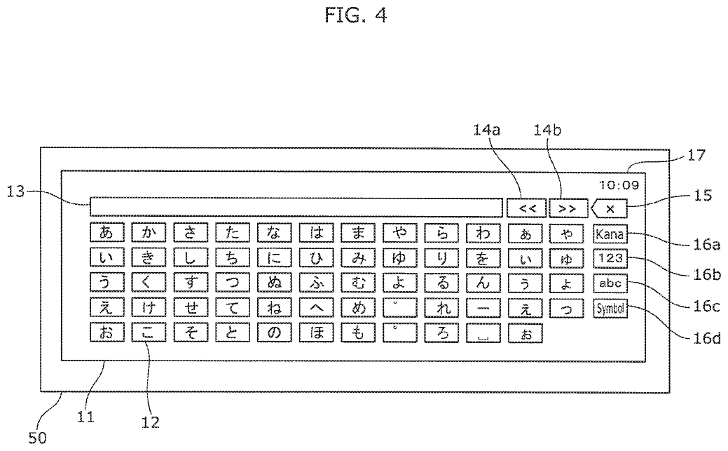

The GUI 11 displayed by the control unit 40 on the display 50 will be described below with reference to FIG. 4.

FIG. 4 is a diagram illustrating an exemplary GUI displayed on the display.

As shown in FIG. 4, the control unit 40 displays the GUI 11 arranged as a keyboard on the display 50. The GUI 11 includes selectable objects 12, 14a, 14b, 15, 16a, 16b, 16c, and 16d. The GUI 11 may also include a display bar 13 arid a clock display 17 indicating the current time. If an input indicating confirmation is received while one of the selectable objects 12, 14a, 14b, 15, 16a, 16b, 16c, and 16d is selected according to the result of detection by the touchpad 30, the control unit 40 performs a specific function associated with the selected selectable object.

Each of the selectable objects 12 is an object for the control unit 40 to receive an input of the kana character corresponding to that selectable object 12. That is, in response to receiving an input for a selectable object 12, the control unit 40 inputs the kana character indicated by the selectable object 12.

The display bar 13 is an area in which characters input by the control unit 40 are displayed.

The selectable object 14a is an object for the control unit 40 to receive an input directing to move a cursor leftward in characters or a character string displayed on the display bar 13. The cursor indicates the position where the next input character is to be displayed. The selectable object 14b is an object for the control unit 40 to receive an input directing to move the cursor rightward in characters or a character string displayed on the display bar 13. Thus, in response to receiving an input for the selectable object 14a or 14b, the control unit 40 moves the cursor leftward or rightward according to the received input in characters or a character string displayed on the display bar 13.

The selectable object 15 is an object for the control unit 40 to receive input directing to delete a character or a character string displayed on the display bar 13. For example, the selectable object 15 is used to delete a character immediately preceding the cursor in characters or a character string displayed on the display bar 13 (i.e., perform the backspace function). Thus, in response to receiving an input for the selectable object 15, the control unit 40 deletes a character immediately preceding the cursor in characters or a character string displayed on the display bar 13.

The selectable objects 16a to 16d are objects for switching among character types indicated by the selectable objects 12 in the GUI 11 arranged as a keyboard on the display 50. For example, the selectable object 16a is an object for switching the characters indicated by the selectable objects 12 to kana characters. The selectable object 16b is an object for switching the characters indicated by the selectable objects 12 to numeric characters. The selectable object 16c is an object for switching the characters indicated by the selectable objects 12 to alphabetic characters. The selectable object 16d is an object for switching the characters indicated by the selectable objects 12 to symbols.

While FIG. 4 shows the example in which the kana-input keyboard layout is displayed in the GUI 11, this is not limiting. The keyboard layout displayed in the GUI 11 may be a numeric-input layout such as the numeric-keypad layout, or an alphabetic-input layout such as the QWERTY layout. Switching among these keyboard layouts is realized in the following manner. The pointer is positioned on any one of the selectable objects 16a, 16b, 16c, and 16d to highlight the selectable object. Then, in response to receiving an input indicating confirmation, the control unit 40 can switch the keyboard layout displayed on the display 50 to the selected layout, such as the kava, numeric, alphabetic, or symbolic layout. Details of the process of determining a selectable object to be highlighted among the selectable objects 12, 14a, 14b, 15, 16a, 16b, 16c, and 16d will be described below.

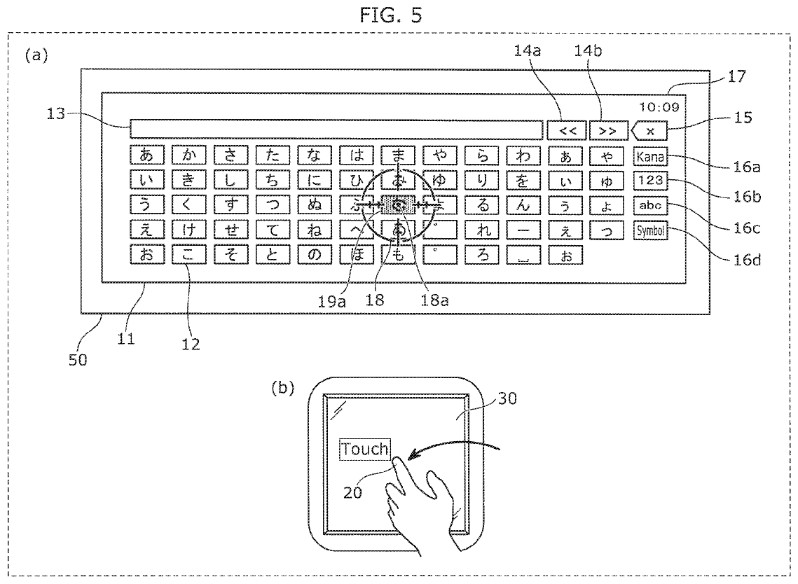

Now, the method of performing input operations in the GUI 11 through the control unit 40 will be specifically described with reference to FIGS. 5 to 9.

FIGS. 5 to 9 are diagrams for describing the method of performing input operations in the GUI.

The representation (a) in FIG. 5 is for describing a pointer 18 displayed in the GUI 11 according to a touch-input to the touchpad 30. The representation (b) in FIG, 5 illustrates the input to the touchpad 30.

The control unit 40 displays the pointer 18 when the operating body 20 touches the touchpad 30. That is, if the touchpad 30 transitions from the state in which no touch of the operating body 20 is detected to the state in which a touch is detected, the control unit 40 displays the pointer 18 that has been hidden on the display 50. Here, the control unit 40 displays the pointer 18 on the display 50 at the position corresponding to the position on the touchpad 30 touched by the operating body 20. The position on the display 50 corresponding to the position on the touchpad 30 refers to a position based on a predetermined correspondence between a coordinate plane that is set on the display 50 and a coordinate plane that is set on the touchpad 30. In other words, the coordinates on the touchpad 30 and the coordinates on the display 50 have a one-to-one correspondence, For example, in the example shown in (a) and (b) in FIG. 5, the touchpad 30 may detect a touch of the operating body 20 at approximately the center of the touchpad 30. The control unit 40 may then display the pointer 18 on the display 50 at the position of the selectable object 19a, which indicates the kana character “mu,” corresponding to approximately the center of the touchpad 30.

The pointer 18 is displayed larger than the selectable objects 12, 14a, 14b, 15, 16a, 16b, 16c, and 16d. Specifically, the pointer 18 has an outer size larger than the outer size of the selectable objects 12, 14a, 14b, 15, 16a, 16b, 16c, and 16d, Each of the selectable objects 12, 14a, 14b, 15, 16a, 16b, 16c, and 16d may have a portion that is not overlapped by the pointer 18 when the pointer 18 is on the selectable object. The user can then see the non-overlapping portion of any of the selectable objects 12, 14a, 14b, 15, 16a, 16b, 16c, and 16d through the pointer 18 thereon to easily recognize the selectable object. For example, the pointer 18 may have a shape such as a target-scope shape with slits on its circumference, or a rectangular shape formed only of the border, through which the selectable object below can be seen at the center. The pointer 18 according to this embodiment has, at its center (centroid), a reference point 18a indicating the position being pointed. That is, the control unit 40 can select a selectable object on which the center (centroid) of the pointer 18 is located. The reference point 18a of the pointer 18 is not limited to the center of the pointer 18 but may be, for example, a point on the upper edge of the pointer 18. While the reference point 18a of the pointer 18 is shown in FIGS. 5, 6, 7, and 9 for the following description, the reference point 18a is actually not displayed. Alternatively, the reference point 18a may be displayed.

When the operating body 20 touches the touchpad 30, the control unit 40 may further highlight, among the selectable objects 12, 14a, 14b, 15, 16a, 16b, 16c, and 16d, the selectable object closest to the position on the display 50 corresponding to the position on the touchpad 30 touched by the operating body 20. Highlighting refers to displaying a highlight-target selectable object in a color different from the color of the other selectable objects, in a size larger than the size of the other selectable objects, or with a thick border around the area of the selectable object. For example, in the example shown in (a) and (b) in FIG. 5, the control unit 40 highlights the selectable object 19a indicating the kana character “mu,” which is the selectable object closest to the position where the pointer 18 is displayed (the position corresponding to the position on the touchpad 30 touched by the operating body 20).

The control unit 40 may also select a selectable object being highlighted. Selecting here refers to the state in which the function associated with a highlighted selectable object is performed in response to a subsequent input indicating confirmation. For example, in the example shown in (a) in FIG. 5, in response to receiving an input indicating confirmation, the control unit 40 accepts the input of the kana character “mu” indicated by the highlighted selectable object 19a and displays the input kana character “mu” on the display bar 13.

The input indicating confirmation to the touchpad 30 has been described as an input at a pressing force greater than the predetermined pressing force. Instead, the input indicating confirmation may be an input in some other manner, such as a double tap.

Now, the movement of the pointer 18 in the GUI 11 when the touchpad 30 detects a sliding operation will be described with reference to FIG, 6. A sliding operation is the operation of moving the operating body 20 while keeping it in contact with the touchpad 30.

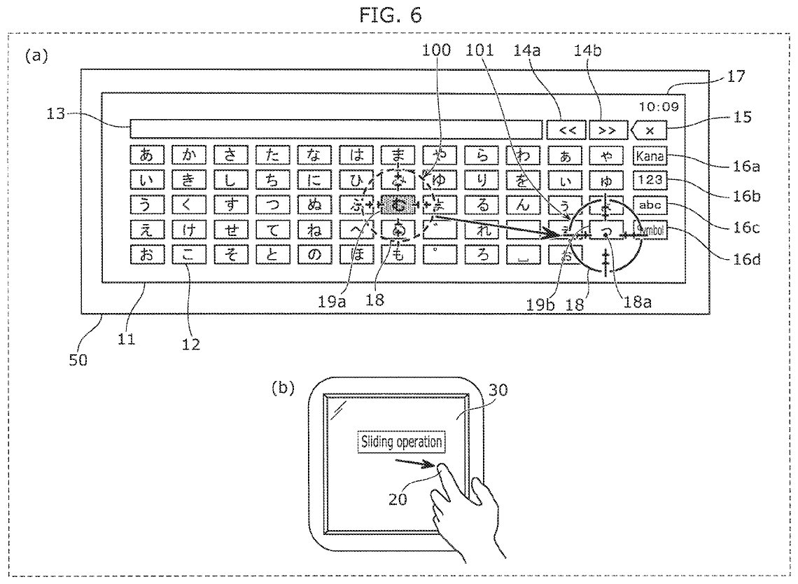

The representation (a) in FIG. 6 is for describing an example of how the control unit 40 displays the pointer 18 in the GUI 11 when the touchpad 30 detects a sliding operation. The representation (b) in FIG. 6 illustrates an exemplary sliding operation on the touchpad 30.

The control unit 40 displays the pointer 18 on the display 50 such that the pointer 18 is moved in the GUI 11 in response to the movement of the operating body 20 on the touchpad 30. Specifically, if a sliding operation of the operating body 20 is detected by the touchpad 30, the control unit 40 moves the pointer 18 along the trajectory of the coordinates on the display 50 corresponding to the trajectory of the input coordinates of the sliding operation on the touchpad 30.

For example, as shown in (b) in FIG. 6, the touchpad 30 may detect a movement in a lower-right direction due to a sliding operation of the operating body 20. Then, as shown in (a) in FIG. 6, the control unit 40 may display the pointer 18 in the GUI 11 to move in a lower-right direction in synchronization with the movement of the operating body 20. In the example shown, the pointer 18 is displayed to move from the position 100 of the selectable object 19a corresponding to the kana character “mu” to the position 101 of the selectable object 19b corresponding to the kana character “tt.”

Here, even though the pointer 18 is displayed at the position 101 of the selectable object 19b corresponding to the kana character “tt” in the GUI 11, the control unit 40 does not immediately highlight the selectable object 19b; the selectable object 19b is not highlighted unless a predetermined condition is satisfied. For a selectable object on which the reference point 18a of the pointer 18 is located, among the selectable objects 12, 14a, 14b, 15, 16a, 16b, 16c, and 16d, the control unit 40 highlights the selectable object on the following condition. The control unit 40 highlights the selectable object if (i) the predetermined reference point 18a stays on the selectable object for a period longer than or equal to a predetermined stay period, and the amount of movement per unit time of the pointer 18 is smaller than or equal to a predetermined amount of movement. Conversely, the control unit 40 does not highlight the selectable object if (ii) the predetermined reference point 18a of the pointer 18 stays on the selectable object for a period shorter than the predetermined stay period, or the amount of movement per unit time of the pointer 18 is larger than the predetermined amount of movement. That is, a selectable object that satisfies the predetermined condition is an object such that the predetermined reference point 18a of the pointer 18 stays on the selectable object for a period longer than or equal to the predetermined stay period, and the amount of movement per unit time of the pointer 18 is smaller than or equal to the predetermined amount of movement.

Therefore, while the pointer 18 is moved, the control unit 40 continues highlighting the selectable object 19a corresponding to the kana character “mu” without switching the highlight to another selectable object unless the predetermined condition is satisfied. Thus, the control unit 40 does not highlight other selectable objects in the path of the pointer 18 from the position 100 to the position 101 unless the sliding operation on the touchpad 30 for moving the pointer 18 is performed slowly enough to cause any selectable object to satisfy the predetermined condition.

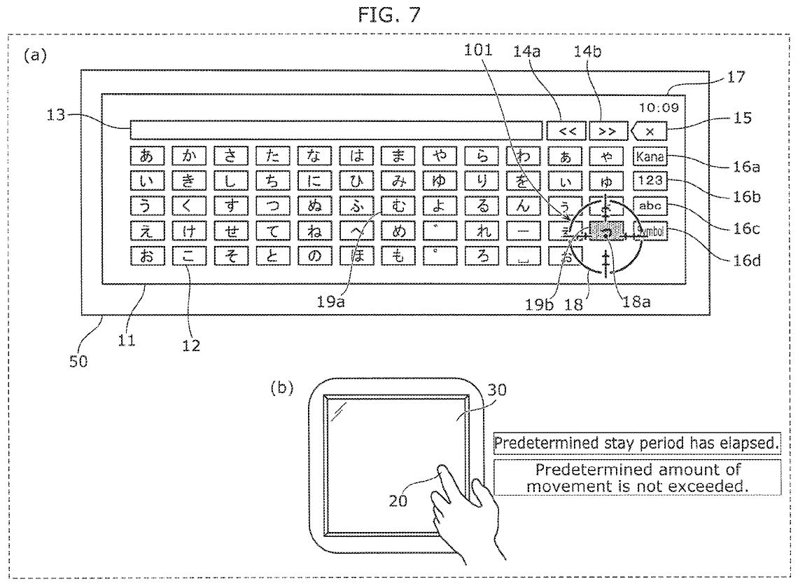

Now, switching the highlight to another selectable object will be described with reference to FIG. 7.

The representation (a) in FIG. 7 is for describing switching the highlight to another selectable object. The representation (b) in FIG. 7 illustrates an exemplary detected input to the touchpad 30 that causes the highlight to be switched. It is to be noted that FIG. 7 shows the scene after the sliding operation in FIG. 6.

As shown in (a) in FIG. 7, if the reference point 18a of the pointer 18 is located on the selectable object 19b, which is different from the selectable object 19a being highlighted, the control unit 40 highlights the selectable object 19b on the condition that (i) the predetermined reference point 18a stays on the selectable object for a period longer than or equal to the predetermined stay period, and the amount of movement per unit time of the pointer 18 is smaller than or equal to the predetermined amount of movement. For example, the control unit 40 highlights the selectable object under the reference point 18a of the pointer 18 on the following condition: the reference point 18a overlaps 98% of the entire rectangular area of the selectable object except the peripheral portion of the rectangular area; the pointer 18 stays in the area for the predetermined stay period of 40 msec; and the amount of movement per unit time of the pointer 18 in the GUI 11 is smaller than or equal to 10 pixels (each pixel corresponds to the coordinate interval that is set in the GUI 11). Here, the unit time in calculating the amount of movement may be the frame rate that is the time interval between time points at which the screen of the GUI 11 on the display 50 is updated, or may be the sampling cycle that is the time interval between time points at which the touchpad 30 performs detection.

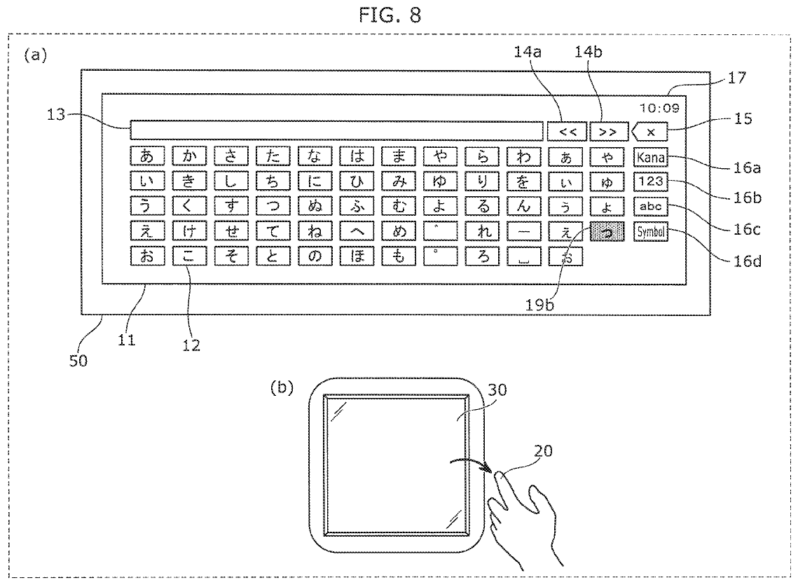

Now, display in the GUI U shown when the operating body 20 is removed from the touchpad 30 will be described with reference to FIG. 8.

The representation (a) in FIG. 8 is for describing the display of the pointer 18 and the highlight of the selectable object occurring when the operating body 20 is removed from the touchpad 30. The representation (b) in FIG. 8 illustrates the operation of removing the operating body 20 from the touchpad 30. It is to be noted that FIG. 8 shows a scene after the highlight is switched to the other selectable object in FIG. 7.

As shown in (a) in FIG. 8, if the operating body 20 is removed from the touchpad 30 and the touchpad 30 no more detects a touch of the operating body 20, the control unit 40 hides the pointer 18. in other words, if the touchpad 30 transitions from the state in which a touch of the operating body 20 is detected to the state in which no touch is detected, the control unit 40 switches the pointer 18 displayed on the display 50 to hidden mode.

The control unit 40 continues highlighting the currently highlighted selectable object 19b until a predetermined standby period elapses from the removal of the operating body 20 from the touchpad 30. That is, until the predetermined standby period elapses after the touchpad 30 transitions from the state in which the touch of the operating body 20 is detected to the state in which no touch is detected, the control unit 40 continues highlighting the selectable object being highlighted at the time of transition. In the example of (a) in FIG. 8, the selectable object 19b is highlighted still after the removal of the operating body 20 from the touchpad 30. After a lapse of the predetermined standby period from the removal of the operating body 20 from the touchpad 30, the control unit 40 stops highlighting the selectable object 19b that has been highlighted.

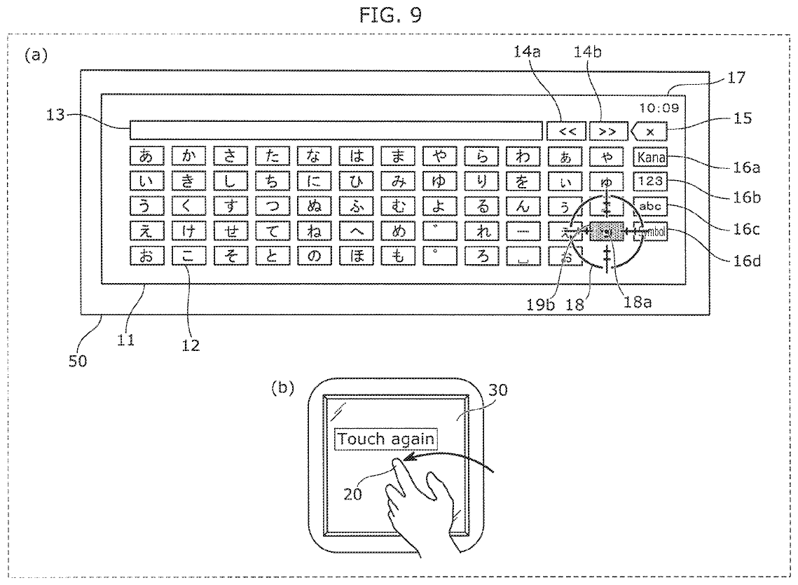

Now, display in the GUI 11 shown when the operating body 20 is removed from the touchpad 30 and again touches the touchpad 30 will be described with reference to FIG. 9.

The representation (a) in FIG. 9 is for describing the display of the pointer 18 and the highlight of the selectable object occurring when the operating body 20 is removed from the touchpad 30 and again touches the touchpad 30. The representation (b) in FIG. 8 illustrates the operation in which the operating body 20 is removed from the touchpad 30 and again touches the touchpad 30. It is to be noted that FIG. 9 shows a scene after the operating body 20 is removed from the touchpad 30 in FIG. 8.

As shown in (a) in FIG. 9, if the operating body 20 touches the touchpad 30 again before a lapse of the predetermined standby period from the removal of the operating body 20 from the touchpad 30, the control unit 40 displays the pointer 18 at the position of the selectable object 19b being highlighted. By contrast, if the operating body 20 touches the touchpad 30 again after a lapse of the predetermined standby period from the removal of the operating body 20 from the touchpad 30, the control unit 40 displays the pointer 18 at the position in the GUI 11 corresponding to the position on the touchpad 30 touched by the operating body (not at the position where the pointer 18 was displayed in the GUI 11 immediately before the removal of the operating body 20 from the touchpad). Thus, in this case, the control unit 40 repeats the operation described with respect to FIG. 5.

### 3. Operations

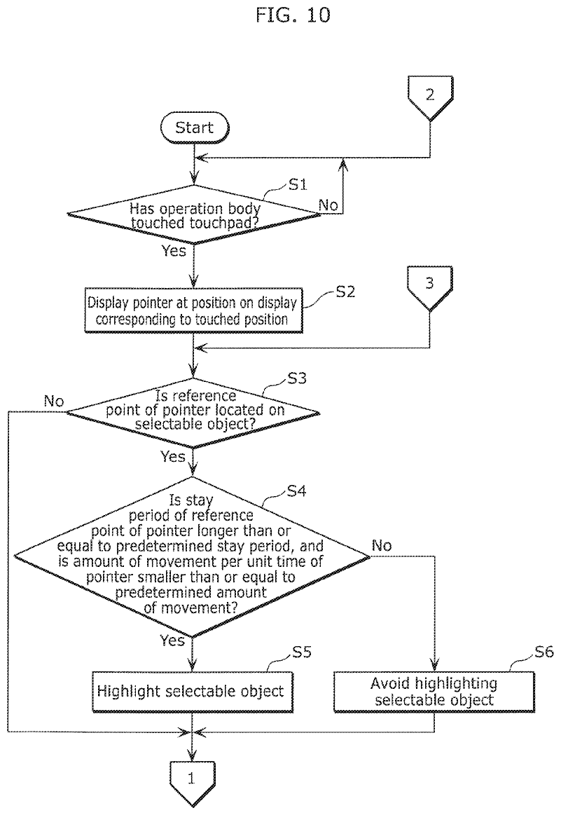

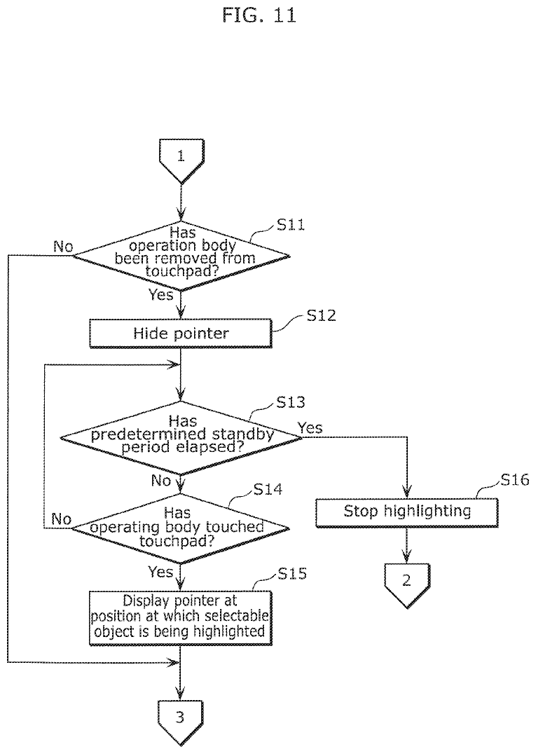

Now, operations in the input apparatus 10 will be described with reference to FIGS. 10 and 11.

FIGS. 10 and 11 are flowcharts illustrating exemplary operations in the input apparatus, according to the embodiment.

The control unit 40 determines whether the operating body 20 has touched the touchpad 30 on the basis of a signal from the touchpad 30 (S1). The signal from the touchpad 30 is an input signal indicating an input to the touch sensor 31 and the pressure sensor 32 of the touchpad 30. The input operation on the pressure sensor 32 has been described with respect to FIG. 2 and therefore will not be described for the operations in FIGS. 10 and 11.

If it is determined that the operating body 20 has touched the touchpad 30 (Yes at S1), the control unit 40 displays the pointer 18 at the corresponding position in the GUI 11 displayed on the display 50 (S2). Here, among the selectable objects 12, 14a, 14b, 15, 16a, 16b, 16c, and 16d, the control unit 40 may highlight the selectable object closest to the position on the display 50 corresponding to the position on the touchpad 30 touched by the operating body 20.

If it is not determined that the operating body 20 has touched the touchpad 30 (No at S1), the control unit 40 returns to step S1.

The control unit 40 determines whether the reference point 18a of the pointer 18 being displayed is located on any of the selectable objects 12, 14a, 14b, 15, 16a, 16b, 16c, and 16d (S3).

If the reference point 18a overlaps any selectable object (Yes at S3), the control unit 40 performs the process starting at step S4 for that selectable object. If the reference point 18a does not overlap any selectable object (No at S3), the control unit 40 performs the process starting at step S11 in FIG. 11 to be described below.

For the selectable object on which the reference point 18a of the pointer 18 is located, the control unit 40 determines whether the reference point 18a stays on the selectable object for a period longer than or equal to the predetermined stay period, and the amount of movement per unit time of the pointer is smaller than or equal to the predetermined amount of movement (S4).

For the selectable object on which the reference point 18a of the pointer 18 is located, if it is determined that the reference point 18a stays on the selectable object for a period longer than or equal to the predetermined stay period and the amount of movement per unit time of the pointer is smaller than or equal to the predetermined amount of movement (Yes at 54), the control unit 40 highlights the selectable object in the GUI 11 (S5).

For the selectable object on which the reference point 18a of the pointer 18 is located, if it is determined that the reference point 18a stays on the selectable object for a period shorter than the predetermined stay period or the amount of movement per unit time of the pointer is larger than the predetermined amount of movement (No at S4), the control unit 40 does not highlight the selectable object in the GUI 11 (S6).

The process proceeds to FIG. 11, where the control unit 40 determines whether the operating body 20 has been removed from the touchpad 30 (S11). Specifically, the control unit 40 determines whether the touchpad 30 has transitioned from the state in which the touch of the operating body 20 is detected to the state in which no touch is detected.

If it is determined that the operating body 20 has been removed from the touchpad 30 (Yes at S11), the control unit 40 hides the pointer 18 at the corresponding position in the GUI 11 to switch the pointer 18 to hidden mode (S12).

If it is not determined that the operating body 20 has been removed from the touchpad 30 (No at S11), the control unit 40 returns to step S3 in FIG. 10.

The control unit 40 determines whether the predetermined standby period has elapsed from the removal of the operating body 20 from the touchpad 30 (S13).

If it is not determined that the predetermined standby period has elapsed from the removal of the operating body 20 from the touchpad 30 (No at step S13), the control unit 40 determines whether the operating body 20 has touched the touchpad 30 again (S14).

If it is determined that the operating body 20 has touched the touchpad 30 again (Yes at S14), the control unit 40 displays the pointer 18 at a position at which the selectable object is being highlighted (S15) and returns to step S3 in FIG. 10.

If it is not determined that the operating body 20 has touched the touchpad 30 again (NO at S14), the control unit 40 returns to step S13.

If it is determined at S13 that the predetermined standby period has elapsed from the removal of the operating body 20 from the touchpad 30 (Yes at step S13), the control unit 40 stops highlighting (S16) and returns to step S1 in FIG. 10.

### 4. Advantageous Effects

The input apparatus 10 according to this embodiment includes the touchpad 30, the display 50, and the control unit 40 that displays the GUI 11 having the selectable objects 12, 14a, 14b, 15, 16a, 16b, 16c, and 16d on the display 50 according to input from the touchpad 30. The control unit 40 displays the pointer 18 on the display 50 such that the pointer 18 is moved in the GUI 11 in response to the movement of the operating body 20 on the touchpad 30. For a selectable object on which the predetermined reference point 18a of the pointer 18 is located, among the selectable objects 12, 14a, 14b, 15, 16a, 16b, 16c, and 16d, the control unit 40 highlights the selectable object on the following condition. The control unit 40 highlights the selectable object if (i) the predetermined reference point 18a stays on the selectable object for a period longer than or equal to the predetermined stay period, and the amount of movement per unit time of the pointer 18 is smaller than or equal to the predetermined amount of movement. Conversely, the control unit 40 does not highlight the selectable object if (ii) the predetermined reference point 18a stays on the selectable object for a period shorter than the predetermined stay period, or the amount of movement per unit time of the pointer 18 is larger than the predetermined amount of movement.

In this manner, not all selectable objects in the GUI 11 on which the pointer 18 stays are highlighted. Rather, a selectable object is highlighted on the limited condition that the pointer 18 stays on the selectable object in the GUI 11 for the predetermined stay period, and that the amount of movement per unit time of the pointer 18 in the GUI 11 is smaller than or equal to the predetermined amount of movement. Thus, while the user is moving the pointer to the user's intended selectable object, the control unit 40 can allow the user to see the displayed pointer 18 to recognize, in real time, how or whether the user can be operating. The control unit 40 can also reduce the likelihood of highlighting selectable objects in the path of the pointer 18 being moved. This leads to reducing visual bother felt by the user operating the input apparatus due to frequent switching of the highlight from one selectable object to another.

In the input apparatus 10 according to this embodiment, when the operating body 20 touches the touchpad 30, the control unit 40 displays the pointer 18 on the display 50 at the position corresponding to the position on the touchpad 30 touched by the operating body 20.

In this manner, when the operating body 20 touches the touchpad 30, the pointer is displayed at the position in the GUI 11 corresponding to the coordinate position on the touchpad 30. As such, the pointer 18 can be displayed at a position close to the user's intended selectable object among the selectable objects in the GUI 11 displayed on the display 50. This enables the user to move the pointer 18 more quickly to the user's intended selectable object. This can also effectively support the user's intuitive operation,

In the input apparatus 10 according to this embodiment, the control unit 40 hides the pointer 18 when the operating body 20 is removed from the touchpad 30. In this manner, the pointer 18 is displayed in the GUI 11 while the operating body 20 touches the touchpad 30, and hidden while the operating body 20 does not touch the touchpad 30. This enables more intuitive display of the GUI 11 according to the user's operational situation.

In the input apparatus 10 according to this embodiment, when the operating body 20 touches the touchpad 30, the control unit 40 highlights, among the selectable objects 12, 14a, 14b, 15, 16a, 16b, 16c, and 16d, the selectable object closest to the position on the display 50 corresponding to the position on the touchpad 30 touched by the operating body 20.

In this manner, a selectable object close to the user's intended position in the GUI 11 can be highlighted when the operating body 20 touches the touchpad 30. This enables the user to select the intended selectable object more quickly. Even if no selectable object exists at the position on the display 50 corresponding to the coordinates on the touchpad 30, a relevant selectable object can be highlighted. The user can thus cause a selectable object to be highlighted without making minute adjustment of the position of the operating body 20 on the touchpad 30 in order to select the selectable object. Because the pointer 18 is displayed at the position in the GUI 11 corresponding to the position on the touchpad 30, the user's intuitive operation can be effectively supported.

In the input apparatus 10 according to this embodiment, the control unit 40 continues highlighting the currently highlighted selectable object until the predetermined standby period elapses from the removal of the operating body 20 from the touchpad 30. After a lapse of the predetermined standby period, the control unit stops highlighting the selectable object.

In this manner, the selectable object remains highlighted for the predetermined standby period after the operating body 20 is removed from the touchpad 30. As such, even if the user temporarily removes the operating body 20 from the touchpad 30, the user can resume the operation in the state in which the currently highlighted selectable object is selected. This enables the user to continue the operation without troubles. After a lapse of the predetermined standby period from the removal of the operating body 20 from the touchpad 30, the highlighting of the selectable object is stopped. Another selectable object can then become the target to be highlighted.

In the input apparatus 10 according to this embodiment, when the operating body 20 touches the touchpad 30 again before a lapse of the predetermined standby period from the removal of the operating body 20 from the touchpad 30, the control unit 40 displays the pointer 18 at a position at which the selectable object is being highlighted. Thus, even if the operating body 20 is removed from the touchpad 30 against the user's will, the user can immediately resume the operation of selecting the intended selectable object.

In the input apparatus 10 according to this embodiment, the control unit 40 selects a selectable object when highlighting the selectable object. That is, the control unit 40 selects a selectable object highlighted under the predetermined condition, rather than simply selecting a selectable object on which the pointer 18 stays. Therefore, selection of a selectable object is switched less frequently than in conventional art, so that the user's intuitive operation can be effectively supported.

In the input apparatus 10 according to this embodiment, the pointer 18 is displayed larger than the selectable object 12, 14a, 14b, 15, 16a, 16b, 16c, and 16d. Thus, the pointer or the selectable object under the pointer can be displayed in a manner that facilitates the user's visual recognition.

In the input apparatus 10 according to this embodiment, the pointer 18 has a portion that does not overlap any of the selectable objects when the pointer 18 is on the selectable object. Thus, the pointer 18 and a selectable object can be displayed to overlap in the GUI 11 in a manner that facilitates the user's visual recognition and identification of the selectable object.

### 5. Variations

In the above-described embodiment, the exemplary condition to be satisfied by the pointer 18 for highlighting a selectable object is that the reference point 18a overlaps 98% of the entire rectangular area of the selectable object except the peripheral portion of the rectangular area, the pointer 18 stays at the position for the predetermined period of 40 msec, and the amount of movement per frame rate of the pointer 18 in the GUI 11 is smaller than or equal to than 10 pixels (coordinate intervals). However, specific values of the condition to be satisfied by the pointer 18 are not limited to the above values. In addition to the amount of movement in the GUI 11, the variation in the amount of movement in the GUI 11 may be employed as an index. The values set in the condition may be arbitrarily changed depending on the characteristics of the user or of the use environment.

While the GUI 11 displayed on the display 50 in the above embodiment is a screen arranged as a keyboard, this is not limiting. For example, the GUI 11 may be a GUI displaying a map for a car navigation system, a GUI of an operation screen for operating an in-vehicle device such as an audio device or air conditioner, a GUI for searching in an Internet browser, or a GUI of a screen for browsing websites. For any GUI, the technical features of the present disclosure can be utilized. Each of the selectable objects displayed in the GUI 11 is an object that causes a predetermined function to be implemented when the control unit 40 receives an input for the selectable object, and it may be an icon, for example. For example, a selectable object may be an icon for turning a switch of the input apparatus 10 on or off.

In the above-described embodiment, FIGS. 5 to 9 show the pointer 18 as a target scope in approximately circular shape. However, the pointer 18 is not limited to such a shape but may be in rectangular, arrow, or finger shape.

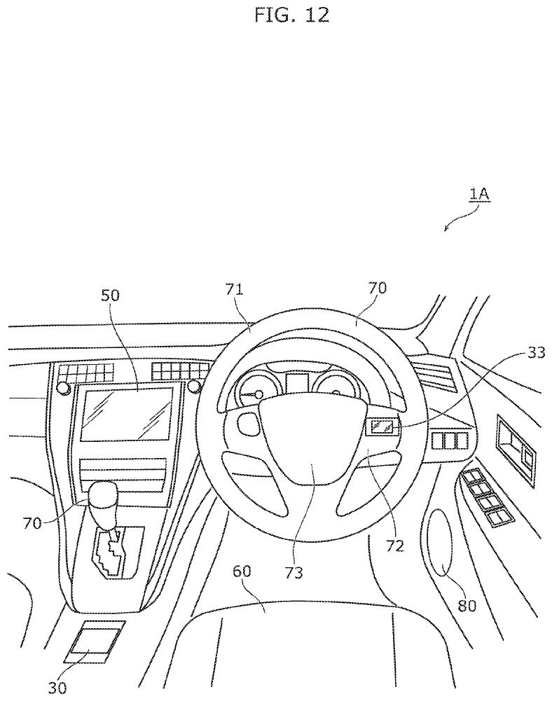

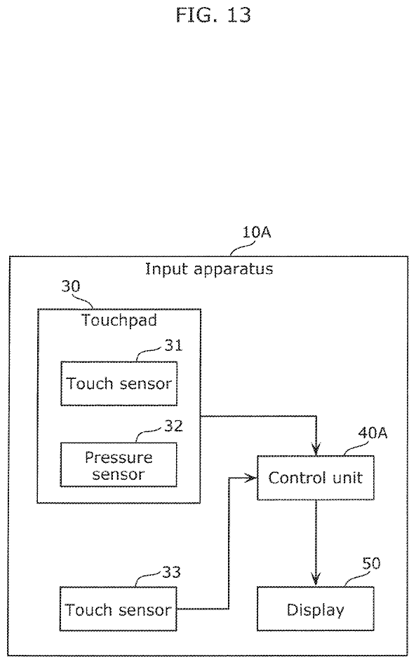

In the above-described embodiment, the touch sensor used is the touchpad 30 disposed at a position in the automobile 1 that is not a position on the steering wheel 70. However, this is not limiting. For example, as illustrated in FIGS. 12 and 13, an input apparatus 10A that includes a touch sensor 33 disposed on the steering wheel 70 of an automobile 1A may be employed.

FIG. 12 is a diagram illustrating an exemplary configuration of an input apparatus and the interior of a vehicle in which the input apparatus is disposed, according to a variation. FIG. 13 is a block diagram illustrating an exemplary functional configuration of the input apparatus provided in an automobile, according to the variation.

The input apparatus 10A according to the variation is different from the input apparatus 10 in the above embodiment only in the functions of the touch sensor 33 and a control unit 40A. Therefore, distinctive functions of the touch sensor 33 and the control unit 40A will be described and other components will not be described.

The touch sensor 33 is disposed on the steering wheel 70. For example, the touch sensor 33 is disposed on any of the spokes 72 of the steering wheel 70.

The driver can operate the input apparatus 10A by providing input to the touch sensor 33 with the driver's thumb or finger of the right hand gripping the rim 71 of the steering wheel 70.

The touch sensor 33 is a sensor that detects a position touched by the user's body part (for example, a finger). When an input is provided to the touch sensor 33, an input signal indicating the input is output to the control unit 40A.

As an input indicating confirmation, the control unit 40A may receive a double-tap input provided from the touch sensor 33, for example, instead of an input indicating confirmation provided from the touchpad 30.

The touch sensor may have a pressure sensor or push switches immediately below the touch sensor 33. In this case, the input indicating confirmation may be a push-in input at a pressing force greater than a predetermined pressing force, instead of a double-tap input.

The display screen associated with touch-input to the touch sensor 33 is not limited to the configuration of the GUI 11 displayed on the display 50 as shown in FIG. 12. For example, the GUI 11 may be displayed on the display 50 provided on a meter panel. In this case, the driver can see the result of operating the touch sensor 33 with a minimum amount of eye movement while driving the automobile. The result of operating the touchpad 30 may also be displayed on the display 50 provided on the meter panel.

It should be noted that in the above embodiment, components may be implemented as dedicated hardware or by executing a software program appropriate for each component. Each component may be realized as a result of a program execution unit of a CPU or processor or the like loading and executing a software program stored in a storage medium such as a hard disk or a semiconductor memory chip. Here, the software that implements, for example, the information processing method according to the above embodiments, is the following type of program.

The program causes a computer to execute an input method for use in an input apparatus including: a touchpad; a display; and a control unit that displays a graphical user interface (GUI) having a plurality of selectable objects in the GUI on the display according to input from the touchpad, the input method including: displaying a pointer on the display such that the pointer is moved in the GUI in response to movement of an operating body on the touchpad; and, for a selectable object on which a predetermined reference point on the pointer is located among the plurality of selectable objects, (i) highlighting the selectable object when the predetermined reference point stays on the selectable object for a period longer than or equal to a predetermined stay period, and an amount of movement per unit time of the pointer is smaller than or equal to a predetermined amount of movement, and (ii) avoiding highlighting the selectable object when the predetermined reference point stays on the selectable object for a period shorter than the predetermined stay period, or the amount of movement per unit time of the pointer is larger than the predetermined amount of movement.

While various embodiments have been described herein above, it is to be appreciated that various changes in form and detail may be made without departing from the spirit and scope of the present disclosure as presently or hereafter claimed.

### FURTHER INFORMATION ABOUT TECHNICAL BACKGROUND TO THIS APPLICATION

The disclosure of the following Japanese Patent Application including specification, drawings and claims is incorporated herein by reference in its entirety: Japanese Patent Application No. 2018-149972 filed on Aug. 9 2018.

### INDUSTRIAL APPLICABILITY

An aspect of the present disclosure is useful as an input apparatus that enables a user to perform selection operations and input operations in a GUI more efficiently than in conventional art without being visually bothered.

1. An input apparatus, comprising:
a touchpad;
a display; and
a control unit configured to display a graphical user interface (GUI) having a plurality of selectable objects on the display according to input from the touchpad,
wherein the control unit is configured to
display a pointer on the display such that the pointer is moved in the GUI in response to movement of an operating body on the touchpad, and
for a selectable object on which a predetermined reference point on the pointer is located among the plurality of selectable objects, (i) highlight the selectable object when the predetermined reference point stays on the selectable object for a period longer than or equal to a predetermined stay period, and an amount of movement per unit time of the pointer is smaller than or equal to a predetermined amount of movement, and (ii) avoid highlighting the selectable object when the predetermined reference point stays on the selectable object for a period shorter than the predetermined stay period, or the amount of movement per unit time of the pointer is larger than the predetermined amount of movement.

2. The input apparatus according to claim 1,
wherein when the operating body touches the touchpad, the control unit is configured to display the pointer at a position on the display corresponding to a position at which the operating body has touched the touchpad.

3. The input apparatus according to claim 1,
wherein the control unit is configured to hide the pointer when the operating body is removed from the touchpad.

4. The input apparatus according to claim 1,
wherein when the operating body touches the touchpad, the control unit is configured to highlight a selectable object, among the plurality of selectable objects, closest to a position on the display corresponding to a position at which the operating body has touched the touchpad.

5. The input apparatus according to claim 1,
wherein the control unit is configured to continue highlighting the selectable object currently highlighted until a predetermined standby period elapses from removal of the operating body from the touchpad, and stop highlighting the selectable object after a lapse of the predetermined standby period.

6. The input apparatus according to claim 5,
wherein when the operating body touches the touchpad again before a lapse of the predetermined standby period from the removal of the operating body from the touchpad, the control unit is configured to display the pointer at a position at which the selectable object is being highlighted.

7. The input apparatus according to claim 1,
wherein the control unit is configured to select the selectable object being highlighted.

8. The input apparatus according to claim 1,
wherein the pointer is displayed larger than the plurality of selectable objects.

9. The input apparatus according to claim 1,
wherein each of the plurality of selectable objects has a portion that is not overlapped by the pointer when the pointer overlaps the selectable object.
